(19) United States
(12) Patent Application Publication
(10) Pub. No.: US 2003/0142149 A1
(43) Pub. Date: Jul. 31, 2003

(54) Specifying audio output according to window graphical characteristics

(75) Inventors: Michael Wayne Brown, Georgetown, TX (US); Andrew Douglas Hately, Austin, TX (US); Kelvin Roderick Lawrence, Round Rock, TX (US); Michael A. Paolini, Austin, TX (US)

Correspondence Address: Marilyn Smith Dawkins, IBM Corporation, Intellectual Property Law Dept., Internal Zip 4054, 11400 Burnet Road, Austin, TX, 78758, US

(73) Assignee: International Business Machines Corporation, Armonk, NY (US)

(21) Appl. No.: 10/058,397

(22) Filed: Jan. 28, 2002

(51) Int. Cl. G09G 5/00

(52) U.S. Cl. 345/978; 345/727; 345/764

(57) ABSTRACT

A method, system, and program for specifying audio output according to displayable object graphical characteristics are provided. A graphical characteristic of at least one displayable object within a user interface is detected. An audio output of a sound associated with at least one displayable object is adjusted to reflect the graphical characteristic, such that the audio output is specified according to a graphical display within the user interface.

### CROSS-REFERENCE TO RELATED APPLICATIONS

The present application is related to the following co-pending applications, which are filed on even date herewith and incorporated herein by reference:

(1) U.S. patent application Ser. No. ______ (Attorney Docket No. AUS920010513US1); and

(2) U.S. patent application Ser. No. ______ (Attorney Docket No. AUS920010514US1);

(3) U.S. patent application Ser. No. ______ (Attorney Docket No. AUS920010515US1);

(4) U.S. patent application Ser. No. ______ (Attorney Docket No. AUS920010516US1);

(5) U.S. patent application Ser. No. ______ (Attorney Docket No. AUS920010517US1);

(6) U.S. patent application Ser. No. ______ (Attorney Docket No. AUS920010518US1);

(7) U.S. patent application Ser. No. ______ (Attorney Docket No. AUS920010519US1);

(8) U.S. patent application Ser. No. ______ (Attorney Docket No. AUS920010521US1);

(9) U.S. patent application Ser. No. ______ (Attorney Docket No. AUS920010522US1);

(10) U.S. patent application Ser. No. ______ (Attorney Docket No. AUS920010524US1); and

(11) U.S. patent application Ser. No. ______ (Attorney Docket No. AUS920010525US1).

### BACKGROUND OF THE INVENTION

1. Technical Field

The present invention relates in general to computer systems and, in particular, to graphical user interfaces. Still more particularly, the present invention relates to adjusting audio output according to graphical characteristics of displayable objects with which sounds are associated.

2. Description of the Related Art

Most operating systems provide a graphical user interface (GUI) for controlling a visual computer environment that represents programs, files, and options with graphical images, such as icons, menus, and dialog boxes on the screen. Graphical items defined within the GUI work the same way for the user in most software because the GUI provides standard software routines to handle these elements and report the user's actions.

A typical graphical object defined by a GUI is a window or other defined area of a display containing distinguishable text, graphics, video, audio and other information for output. A display area may contain multiple windows associated with a single software program or multiple software programs executing concurrently.

Often when multiple graphical objects are displayed concurrently, the graphical objects will overlap. The order in which graphical objects are drawn on top of one another onscreen to simulate depth is typically known as the z-order. Typically, those objects at the top of the z-axis obscure the view of those graphical objects drawn below.

In some operating systems, a level of transparency or translucency may be applied to graphical objects, and in particular to windows. By applying a level of translucency to upper level windows, lower level windows are rendered visible through the upper level windows.

Typically, audio output is limited to the sounds associated with the currently active window and operating system related sounds. However, only allowing audio output of the sounds associated with the active window is limiting, particularly where transparency is applied to windows.

In view of the foregoing, it would be advantageous to provide a method, system, and program for allowing audio output to include sounds associated with multiple windows. In addition, it would be advantageous to provide a method, system, and program for distinguishing sounds according to the graphical characteristics of the associated window.

### SUMMARY OF THE INVENTION

In view of the foregoing, it is therefore an object of the present invention to provide an improved computer system.

It is another object of the present invention to provide an improved graphical user interface.

It is yet another object of the present invention to provide a method, system and program for adjusting audio output according to graphical characteristics of displayable objects with which sounds are associated.

According to one aspect of the present invention, a graphical characteristic of at least one displayable object within a user interface is detected. Graphical characteristics may include the position, the transparency, and resource utilization of at least one displayable object,

An audio output of a sound associated with at least one displayable object is adjusted to reflect the graphical characteristic, such that the audio output is specified according to a graphical display within the user interface. In addition, an environmental effect may be applied in adjusting the sound to reflect the graphical characteristic of the displayable object.

All objects, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 depicts one embodiment of a computer system with which the method, system and program of the present invention may advantageously be utilized;

FIG. 2 illustrates a graphical representation of a user interface where audio output corresponds to the graphical characteristics of associated windows in accordance with the method, system, and program of the present invention;

FIG. 3 depicts a graphical representation of a user interface where windows are z-ordered according to audio utilization in accordance with the method, system, and program of the present invention;

FIG. 4 illustrates a block diagram of audio preferences in accordance with the method, system, and program of the present invention; and

FIG. 5 depicts a high level logic flowchart of a process and program for adjusting sound output according to displayable object graphical characteristics in accordance with the method, system, and program of the present invention.

### DETAILED DESCRIPTION OF THE PREFERRED EMBODIMENT

A method, system, and program for adjusting audio output according to the graphical characteristics of associated windows within a graphical user interface are provided. For purposes of the present invention, graphical characteristics may include the position of a window, the transparency of a window, the color of a window, and other graphical distinguishments within a window.

In addition to windows, audio output may be adjusted according to the graphical characteristics of associated displayable objects. A “displayable object” may include text, icons, video, graphics, windows, or other logical graphical representations displayable within a display area. Displayable objects may be hidden or visible. Further, displayable objects may be layered in a z-order. Moreover, a displayable object may utilize a portion of a display area or may extend across the entirety of a display area. A displayable object may or may not include definable boundaries.

A z-order is the order along the z-axis in which displayable objects appear. Through a z-buffering technique, a depth is associated with each displayable object such that each object appears to be set at a particular depth in comparison with other displayable objects. There may be n-levels of layers within the z-order, where multiple displayable objects may be positioned within a particular n-level of the z-order.

The z-order may be a result of the order in which a user opens displayable objects onto the display. Alternatively, according to one advantage of the present invention, a user may designate for the z-order to be set according to a particular criteria.

Transparency is a graphical feature that is particularly advantageous to the present invention when displaying multiple displayable objects within a user interface where those displayable objects may overlap. As will be understood by one skilled in the art, by making a displayable object appear transparent on a computer screen, other displayable objects positioned below the transparent displayable object are rendered visible through the transparent displayable object. Further, the transparency of a displayable object may be adjusted from opaque to totally transparent.

Typically, the transparency attribute is stored with color values in an alpha channel. Then, when calculating the appearance of a given pixel, the graphic processor uses the alpha channel values to determine the pixel's color through a process termed alpha blending. Through alpha blending, the process adds a fraction of the color of the transparent object set by the alpha channel value to the color of the displayable object below. Mixing the colors together gives the appearance that the displayable object below is seen through a layer of the transparent displayable object. In addition to alpha blending, additional shading may be added to create shadows and other graphical images cue the viewer to the position of the transparent displayable object.

In the following description, for the purposes of explanation, numerous specific details are set forth to provide a thorough understanding of the present invention. It will be apparent, however, to one skilled in the art that the present invention may be practiced without these specific details. In other instances, well-known structures and devices are shown in block diagram form to avoid unnecessarily obscuring the present invention.

### Hardware Overview

The present invention may be executed in a variety of systems, including a variety of computing systems and electronic devices under a number of different operating systems. In one embodiment of the present invention, the computer system is a portable computing system such as a notebook computer, a palmtop computer, a personal digital assistant, a telephone or other electronic computing system that may also incorporate communications features that provide for telephony, enhanced telephony, messaging and information services. However, the computer system may also be, for example, a desktop computer, a network computer, a midrange computer, a server system or a mainframe computer. Therefore, in general, the present invention is preferably executed in a computer system that performs computing tasks such as manipulating data in storage that is accessible to the computer system. In addition, the computer system preferably includes at least one output device and at least one input device.

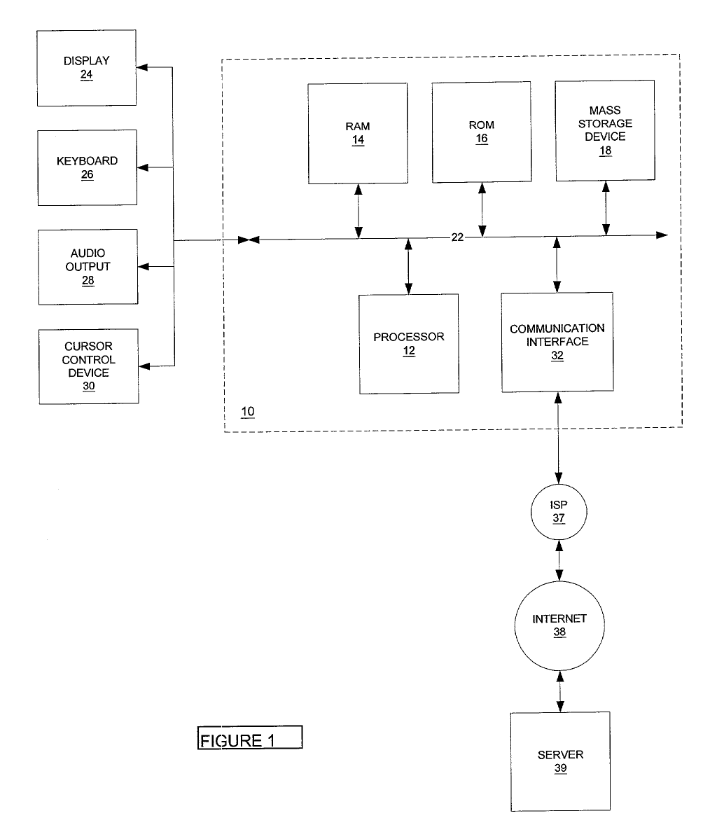

Referring now to the drawings and in particular to FIG. 1, there is depicted one embodiment of a computer system with which the method, system and program of the present invention may advantageously be utilized. Computer system 10 comprises a bus 22 or other communication device for communicating information within computer system 10, and at least one processing device such as processor 12, coupled to bus 22 for processing information. Bus 22 preferably includes low-latency and high-latency paths that are connected by bridges and controlled within computer system 10 by multiple bus controllers.

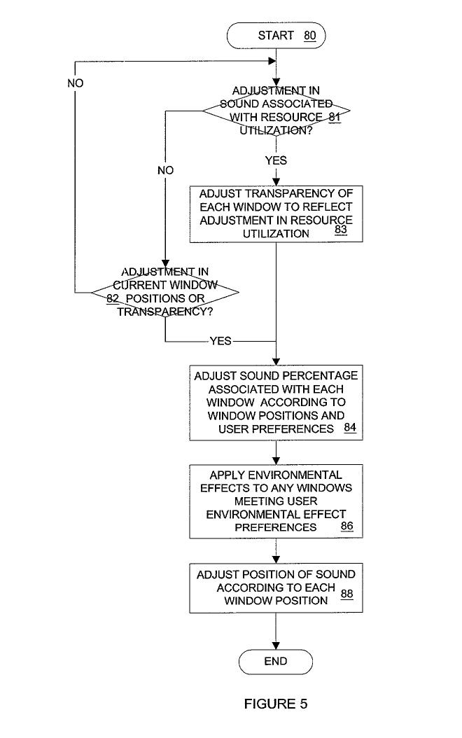

Processor 12 may be a general-purpose processor such as IBM's PowerPC™ processor that, during normal operation, processes data under the control of operating system and application software stored in a dynamic storage device such as random access memory (RAM) 14 and a static storage device such as Read Only Memory (ROM) 16. The operating system preferably provides a graphical user interface (GUI) to the user. In a preferred embodiment, application software contains machine executable instructions that when executed on processor 12 carry out the operations depicted in the flowcharts of FIG. 5 and others described herein. Alternatively, the steps of the present invention might be performed by specific hardware components that contain hardwire logic for performing the steps, or by any combination of programmed computer components and custom hardware components.

The present invention may be provided as a computer program product, included on a machine-readable medium having stored thereon the machine executable instructions used to program computer system 10 to perform a process according to the present invention. The term “machine-readable medium” as used herein includes any medium that participates in providing instructions to processor 12 or other components of computer system 10 for execution. Such a medium may take many forms including, but not limited to, non-volatile media, volatile media, and transmission media. Common forms of non-volatile media include, for example, a floppy disk, a flexible disk, a hard disk, magnetic tape or any other magnetic medium, a compact disc ROM (CD-ROM), a digital video disc-ROM (DVD-ROM) or any other optical medium, punch cards or any other physical medium with patterns of holes, a programmable ROM (PROM), an erasable PROM (EPROM), electrically EPROM (EEPROM), a flash memory, any other memory chip or cartridge, or any other medium from which computer system 10 can read and which is suitable for storing instructions. In the present embodiment, an example of non-volatile media is storage device 18. Volatile media includes dynamic memory such as RAM 14. Transmission media includes coaxial cables, copper wire or fiber optics, including the wires that comprise bus 22. Transmission media can also take the form of acoustic or light waves, such as those generated during radio wave or infrared data communications.

Moreover, the present invention may be downloaded as a computer program product, wherein the program instructions may be transferred from a remote computer such as a server 39 to requesting computer system 10 by way of data signals embodied in a carrier wave or other propagation medium via a network link 34 (e.g., a modem or network connection) to a communications interface 32 coupled to bus 22. Communications interface 32 provides a two-way data communications coupling to network link 34 that may be connected, for example, to a local area network (LAN), wide area network (WAN), or as depicted herein, directly to an Internet Service Provider (ISP) 37. In particular, network link 34 may provide wired and/or wireless network communications to one or more networks.

ISP 37 in turn provides data communication services through the Internet 38 or other network. Internet 38 may refer to the worldwide collection of networks and gateways that use a particular protocol, such as Transmission Control Protocol (TCP) and Internet Protocol (IP), to communicate with one another. ISP 37 and Internet 38 both use electrical, electromagnetic, or optical signals that carry digital or analog data streams. The signals through the various networks and the signals on network link 34 and through communication interface 32, which carry the digital or analog data to and from computer system 10, are exemplary forms of carrier waves transporting the information.

Further, multiple peripheral components may be added to computer system 10. For example, an audio output 28 is attached to bus 22 for controlling audio output through a speaker or other audio projection device. A display 24 is also attached to bus 22 for providing visual, tactile or other graphical representation formats. A keyboard 26 and cursor control device 30, such as a mouse, trackball, or cursor direction keys, are coupled to bus 22 as interfaces for user inputs to computer system 10. Keyboard 26 and cursor control device 30 can control the position of a cursor positioned within a display area of display 24. Display 24 may include both non-transparent surfaces, such as monitors, and transparent surfaces, such as headset sunglasses or vehicle windshield displays.

It should be understood that keyboard 26 and cursor control device 30 are examples of multiple types of input devices that may be utilized in the present invention. In alternate embodiments of the present invention, additional input and output peripheral components may be added.

### Recently Used Translucency Context

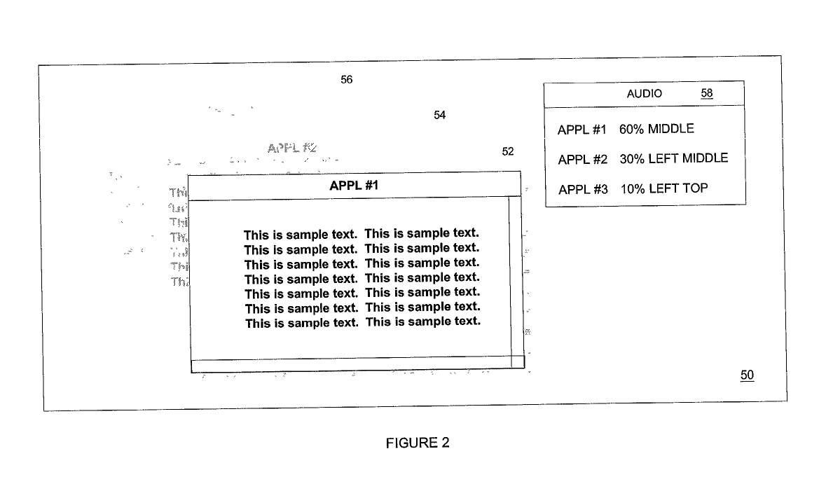

Referring now to FIG. 2, there is depicted a graphical representation of a user interface where audio output corresponds to the graphical characteristics of associated windows in accordance with the method, system, and program of the present invention. As illustrates, a user interface 50 includes windows 52, 54, and 56. In the present example, window 52 is positioned at the top level of the z-order, followed in position by window 54, and then window 56. As depicted, each of windows 52, 54, and 56 are set at a particular level of transparency. In the present example, window 52 is set at 0% transparency, while window 54 is set at 30% transparency and window 52 set at 50% transparency. The levels of transparency associated with windows may be reflective of multiple factors including, but not limited to, recent use, resource utilization, and other measurable factors.

According to one advantage of the present invention, audio associated with multiple windows may be output simultaneously, independent of whether windows are active or not. For example, audio associated with window 52 may be output simultaneously with audio associated with window 54.

According to another advantage of the present invention, audio volumes may be independently selected according to the transparency of the window associated with the audio. Advantageously, a graphical indicator, such as an audio specification window 58, indicates the current windows and volume percentage associated therewith.

In the present example, the percentage of the total volume is divided in relation to the percentage of transparency of each window. For example, window 52 is displayed at 0% transparency, and 60% of the total volume is displaced by audio associated with window 52. Window 54 is displayed at 30% transparency and 30% of the total volume is displaced by audio associated with window 54. Window 56 is displayed at 60% transparency and 10% of the total volume is displaced by audio associated with window 56.

According to a further advantage of the present invention, the dimensional position of audio output may parallel the positions of windows within user interface 50. Particularly where multiple speaker outputs are available, the frequency and tone of sound may be adjusted to create the sound of coming from multiple points.

In the present example, window 56 is located in the top left corner of user interface 50. Therefore the audio associated with window 56 is preferably output to sound as if it is coming from the top left corner of the sound area.

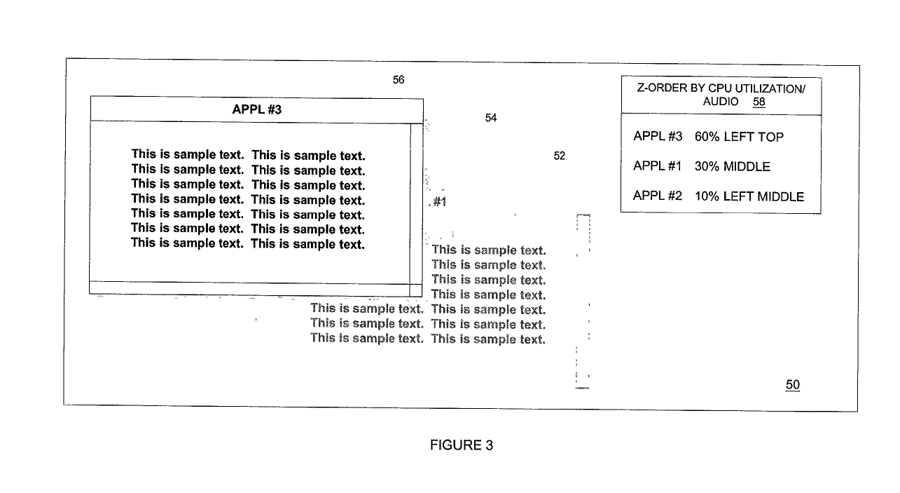

With reference now to FIG. 3, there is illustrated a graphical representation of a user interface where windows are z-ordered according to audio utilization in accordance with the method, system, and program of the present invention. Advantageously, windows 52, 54 and 56 may be z-ordered according to CPU utilization. In the example, the transparency of the windows 52, 54, and 56 is tied to the z-ordering criteria, and is thus selected to reflect CPU utilization by each window. Then, the audio output in association with each of windows 52, 54, and 56 is gauged to reflect the transparency of each of windows 52, 54, and 56. Therefore, ultimately, audio output reflects the criteria utilized to z-order windows. As the transparency of windows adjusts according to z-ordering criteria, the audio percentage distribution preferably re-distributes.

In the present example, the criteria utilized for z-ordering windows has adjusted in comparison with the criteria utilized in FIG. 2. The transparency of the windows has adjusted to reflect the new z-ordering criteria. In particular, the CPU utilization associated with window 56 is greater than the utilization associated with windows 52 and 54. The transparency of the windows is adjusted accordingly. According to the transparency of the windows, 60% of the total volume is distributed to the audio associated with window 56.

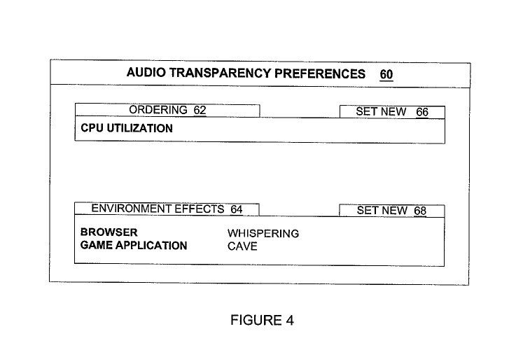

Referring now to FIG. 4, there is depicted a block diagram of audio preferences in accordance with the method, system, and program of the present invention. As illustrated, audio preferences 60 includes criteria for z-ordering windows, such as ordering criteria 62. For example, CPU utilization may be set as a criteria for the z-order of windows. Preferably, a user may adjust criteria for ordering windows by selecting selectable button 66.

In addition, audio preferences 60 may include criteria for environmental effects, such as environmental effects criteria 66. For example, environmental effects criteria may designate audio output in association with a browser window to be whispered. In another example, environmental effects criteria may designate audio output in association with a game application to be output as if in a cave. Further, environmental effects criteria may designate audio output in associated with a window that is behind another window to be muffled in order to output the effect that the sound is behind an object.

Preferably, a user may adjust environmental effect criteria by selecting selectable button 68. In addition, while in the present example environmental effects criteria are designated according to type of window, in alternate embodiments, environmental effects criteria may be designated according to specific applications, specific windows, groups of windows, and other criteria.

With reference now to FIG. 5, there is illustrated a high level logic flowchart of a process and program for adjusting sound output according to displayable object graphical characteristics in accordance with the method, system, and program of the present invention. As depicted, the process starts at block 80 and thereafter proceeds to block 81.

Block 81 depicts a determination as to whether or not an adjustment in sound associated with resource utilization is detected. For example, CPU utilization by audio may be designated as a sound associated resource utilization preference. If an adjustment in sound associated resource utilization is not detected, then the process passes to block 82. If an adjustment in sound associated resource utilization is detected, then the process passes to block 83. Block 83 illustrates adjusting the transparency of each window to reflect the adjustment in resource utilization. Next, the process passes to block 82.

Block 82 illustrates a determination as to whether or not there is an adjustment in current window positions or transparency. If there are not adjustments in current window position or transparency, then the process returns to block 81. If there are adjustments in current window position or transparency, then the process passes to block 84.

Block 84 depicts adjusting the sound percentage associated with each window according to window positions and user preferences. Next, block 86 illustrates applying environmental effects to any windows meeting user environmental effect preference criteria. Thereafter, block 88 depicts adjusting the position of each sound to reflect the position of each associated window; and the process ends.

While the invention has been particularly shown and described with reference to a preferred embodiment, it will be understood by those skilled in the art that various changes in form and detail may be made therein without departing from the spirit and scope of the invention.

What is claimed is:

1. A method for specifying audio output, said method comprising the steps of:
detecting a graphical characteristic of at least one displayable object within a user interface; and
adjusting an audio output of a sound associated with said at least one displayable object to reflect said graphical characteristic, such that said audio output is specified according to a graphical display within said user interface.

2. The method for specifying audio output according to claim 1, said step of detecting a graphical characteristic further comprising the step of:
detecting said graphical characteristic of said at least one displayable object, wherein said graphical characteristic comprises a graphical position of said at least one displayable object.

3. The method for specifying audio output according to claim 2, said method further comprising the step of:
adjusting said audio output of said sound, wherein a positional source of said audio output reflects said graphical position of said at least one displayable object.

4. The method for specifying audio output according to claim 1, said step of detecting a graphical characteristic further comprising the step of:
detecting said graphical characteristic of said at least one displayable object, wherein said graphical characteristic comprises a transparency of said at least one displayable object.

5. The method for specifying audio output according to claim 1, said step of detecting a graphical characteristic further comprising the step of:
detecting said graphical characteristic of said at least one displayable object, wherein said graphical characteristic is determined by a resource utilization of said at least one displayable object.

6. The method for specifying audio output according to claim 1, said step of detecting a graphical characteristic further comprising the step of:
adjusting said sound according to an environmental effect associated with said at least one displayable object.

7. The method for specifying audio output according to claim 1, said method further comprising the step of:
adjusting said audio output of said sound associated with said at least one displayable object according to a relative z-order position of said at least one displayable object.

8. The method for specifying audio output according to claim 1, said step of adjusting an audio output of a sound, further comprising the step of:
adjusting said audio output of said sound according to user audio preferences.

9. The method for specifying audio output according to claim 1, said step of adjusting an audio output of a sound, further comprising the step of:
adjusting said audio output of said sound associated with said at least one displayable object to reflect said graphical characteristic, wherein a positional source of said audio output reflects a position of said at least one displayable object.

10. A system for specifying audio output, said system comprising:
a graphical user interface;
means for detecting a graphical characteristic of at least one displayable object displayed within said graphical user interface; and
means for adjusting an audio output of a sound associated with said at least one displayable object to reflect said graphical characteristic.

11. The system for specifying audio output according to claim 10, wherein said graphical characteristic comprises a graphical position of said at least one displayable object.

12. The system for specifying audio output according to claim 11, wherein a positional source of said audio output reflects said graphical position of said at least one displayable object.

13. The system for specifying audio output according to claim 10, wherein said graphical characteristic comprises a transparency of said at least one displayable object.

14. The system for specifying audio output according to claim 10, wherein said graphical characteristic is determined by a resource utilization of said at least one displayable object.

15. The system for specifying audio output according to claim 10, said means for detecting a graphical characteristic further comprising:
means for adjusting said sound according to an environmental effect associated with said at least one displayable object.

16. The system for specifying audio output according to claim 10, said system further comprising:
means for adjusting said audio output of said sound associated with said at least one displayable object according to a relative z-order position of said at least one displayable object.

17. The system for specifying audio output according to claim 10, said means for adjusting an audio output of a sound, further comprising:
means for adjusting said audio output of said sound according to user audio preferences.

18. The system for specifying audio output according to claim 10, wherein a positional source of said audio output reflects a position of said at least one displayable object.

19. A program for specifying audio output, residing on a computer usable medium having computer readable program code means, said program comprising:
means for detecting a graphical characteristic of at least one displayable object within a user interface; and
means for controlling adjustment of an audio output of a sound associated with said at least one displayable object to reflect said graphical characteristic.

20. The program for specifying audio output according to claim 19, said program further comprising:
means for detecting said graphical characteristic comprising a graphical position of said at least one displayable object.

21. The program for specifying audio output according to claim 20, said program further comprising:
means for controlling adjustment of said audio output of said sound, wherein a positional source of said audio output reflects said graphical position of said at least one displayable object.

22. The program for specifying audio output according to claim 19, said program further comprising:
means for detecting said graphical characteristic comprising a transparency of said at least one displayable object.

23. The program for specifying audio output according to claim 19, said program further comprising:
means for detecting said graphical characteristic comprising a resource utilization of said at least one displayable object.

24. The program for specifying audio output according to claim 19, said program further comprising:
means for controlling adjustment of said sound according to an environmental effect associated with said at least one displayable object.

25. The program for specifying audio output according to claim 19, said program further comprising:
means for controlling adjustment of said audio output of said sound associated with said at least one displayable object according to a relative z-order position of said at least one displayable object.

26. The program for specifying audio output according to claim 19, said program further comprising:
means for controlling adjustment of said audio output of said sound according to user audio preferences.

27. The program for specifying audio output according to claim 19, said program further comprising:
means for controlling adjustment of said audio output of said sound associated with said at least one displayable object to reflect said graphical characteristic, wherein a positional source of said audio output reflects a position of said at least one displayable object.
